(19) United States
(12) Patent Application Publication
(10) Pub. No.: US 2021/0042480 A1
(43) Pub. Date: Feb. 11, 2021

(54) WIRELESS TAG WRITING APPARATUS AND WRITING METHOD BY WIRELESS TAG WRITING APPARATUS

(71) Applicant: TOSHIBA TEC KABUSHIKI KAISHA, Toyota (JP)

(72) Inventor: Takashi GOTO, Fuji Shizuoka (JP)

(21) Appl. No.: 16/839,487

(22) Filed: Apr. 3, 2020

(30) Foreign Application Priority Data
Aug. 6, 2019 (JP) 2019-144518

(51) Int. Cl. G06K 7/10

(52) U.S. Cl. CPC G06K 7/10198

(57) ABSTRACT

According to an embodiment, a wireless tag writing apparatus includes a wireless reader, a wireless reader/writer, and a processor. The wireless reader reads tag information from wireless tags at a position in the vicinity of a transport path of a label release liner. The wireless tags are disposed on the label release liner. The wireless reader/writer reads the tag information from the wireless tags at a position on a downstream side of the transport path from a position of the wireless reader. The processor controls the wireless reader/writer to write information to the wireless tag if the tag information that has been read by the wireless reader/writer is the same as the tag information that has been read by the wireless reader.

### CROSS-REFERENCE TO RELATED APPLICATIONS

This application is based upon and claims the benefit of priority from the prior Japanese Patent Application No. 2019-144518, filed on Aug. 6, 2019, the entire contents of which are incorporated herein by reference.

### FIELD

An embodiment to be described here generally relates to a wireless tag writing apparatus and a wiring method by the wireless tag writing apparatus.

### BACKGROUND

In the past, some labels to be attached to products have a wireless tag typified by an RFID (Radio Frequency IDentification) tag formed thereon. Product information is printed on the label. Further, data relating to a product (hereinafter, referred to simply as the product data) is written to the wireless tag. On the basis of the product information and the product data, sales management, inventory management, loading/unloading management, and the like of articles regarding the product or the like to which the label is attached are performed. The RFID tag includes, for example, an IC (integrated circuit) chip capable of reading data by radio waves in a predetermined frequency band in a non-contact manner.

The above-mentioned writing of product data to the RFID tag is performed by using an RFID reader/writer on RFID tags attached to a label release liner in a row. Specifically, the RFID reader/writer interrogates an RFID tag with a radio wave and then receives a response radio wave from the RFID tag to read information stored in the RFID tag. Further, the RFID reader/writer irradiates the RFID tag with a radio wave to write information such as the above-mentioned product data to the RFID tag. Here, for example, in the case where the range of radio waves to be emitted from the RFID reader/writer is set wide, the preceding and following RFID tags of a RFID tag to be written might also respond to the RFID reader/writer with a radio wave stronger than that of the RFID tag to be written, depending on the status of the response radio wave from the preceding and following RFID tags of the RFID tag to be written in some cases. As a result, the RFID reader/writer writes product data to the above-mentioned preceding and following RFID tags that are not the RFID tags to be written in some cases.

### BRIEF DESCRIPTION OF THE DRAWINGS

FIG. 1 is an external view showing an example of an RFID tag according to an embodiment, which is formed on a label sheet attached to a label release liner.

FIG. 2 is a schematic diagram showing an example of an information storage area of a memory of the RFID tag according to the embodiment.

FIG. 3 is a schematic diagram an RFID printer apparatus according to the embodiment.

FIG. 4 is a hardware block diagram showing an example of a hardware configuration of the RFID printer apparatus according to the embodiment.

FIG. 5 is a functional block diagram showing an example of a functional configuration of the RFID printer apparatus according to the embodiment.

FIG. 6 is a diagram describing a method of specifying the arrangement order of RFID tags on the basis of information acquired by a first reading unit according to the embodiment.

FIG. 7 is a flowchart showing an example of processing performed by the RFID printer apparatus according to embodiment.

### DETAILED DESCRIPTION

According to an embodiment, a wireless tag writing apparatus includes a transport mechanism, a storage device, a wireless reader, a wireless reader/writer, and a processor. The transport mechanism transports a label release liner on a predetermined transport path. A plurality of label sheets is disposed on the label release liner. Wireless tags are formed on each of the respective label sheets. The wireless tags store tag information relating to the corresponding wireless tag. The storage device stores information corresponding to the tag information stored in the corresponding wireless tag. The wireless reader applies a radio wave to the wireless tag on the label release liner transported on the transport path by the transport mechanism. The wireless reader sequentially reads, by applying the radio wave, the tag information from all of the wireless tags on the label release liner transported on the transport path. The wireless reader/writer applies a radio wave to the wireless tag on the label release liner. The wireless reader/writer reads, by applying the radio wave, the tag information from the wireless tag at a position on a downstream side from a position of the wireless reader in a transport direction of the label release liner, and writes information corresponding to the tag information stored in the storage device to the wireless tag. If the wireless reader/writer has read the same tag information as the tag information that has been read from the wireless tag by the wireless reader, the processor controls the wireless reader/writer to cause the wireless reader/writer to write, by applying a radio wave to the wireless tag storing the same tag information that has been read by the wireless reader, the information corresponding to the tag information that has been read by the wireless reader among pieces of information stored in the storage device to the wireless tag.

Hereinafter, a wireless tag writing apparatus according to an embodiment will be described with reference to the drawings in detail. In the drawings, the same reference symbols indicate the same or similar components. Note that the embodiment described below is an example in which a wireless tag writing apparatus is applied to an RFID printer apparatus. That is, an RFID printer apparatus is an example of a wireless tag writing apparatus.

(Structure of RFID Tag)

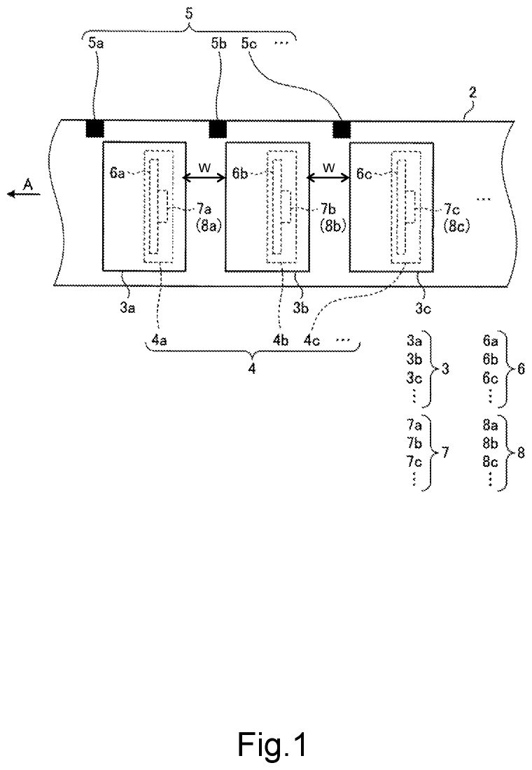

First, an RFID tag that is a target of reading and writing information in an RFID printer apparatus according to an embodiment will be described. FIG. 1 shows an example of RFID tags 4 (4a, 4b, 4c, . . . ) formed on label sheets 3 (3a, 3b, 3c, . . . ) attached to a label release liner 2.

The label release liner 2 is transported in a transport direction A by a transport mechanism including a transport roller 11 and a platen roller 15, which will be described below. The plurality of label sheets 3 (3a, 3b, 3c, having the same rectangular shape is attached to the surface of the label release liner 2 in a row along the longitudinal direction of the label release liner 2, i.e., the transport direction A, at a predetermined interval W. The RFID tags 4 (4a, 4b, 4c, . . . ) that are wireless communication medium are formed on the respective label sheets 3. Specifically, the RFID tags 4(4a, 4b, 4c, . . . ) that are wireless communication medium are formed on a side of the respective label sheets 3, the respective label sheets 3 being attached to the label release liner 2 on the side. In other words, the RFID tags 4 are formed in the vicinity of the respective label sheets 3 or so as to overlap the respective label sheets 3. The RFID tags 4 all have the same shape and the same structure. The respective RFID tags 4 include antennas (6a, 6b, 6c, . . . ) and the IC chips 7 (7a, 7b, 7c, . . . ) disposed therein.

The antennas 6 (6a, 6b, 6c, . . . ) receive radio waves emitted from the outside of the RFID tags 4. Further, the antennas 6 (6a, 6b, 6c, . . . ) each apply a response radio wave corresponding to the received radio wave to the surroundings toward the outside of the RFID tags 4. The longitudinal direction of the antennas 6 of the RFID tags 4 is orthogonal to the transport direction A of the label release liner 2. That is, the RFID tags 4 are formed on the label sheets 3 so that the longitudinal direction of the antennas 6 is orthogonal to the transport direction A of the label release liner 2.

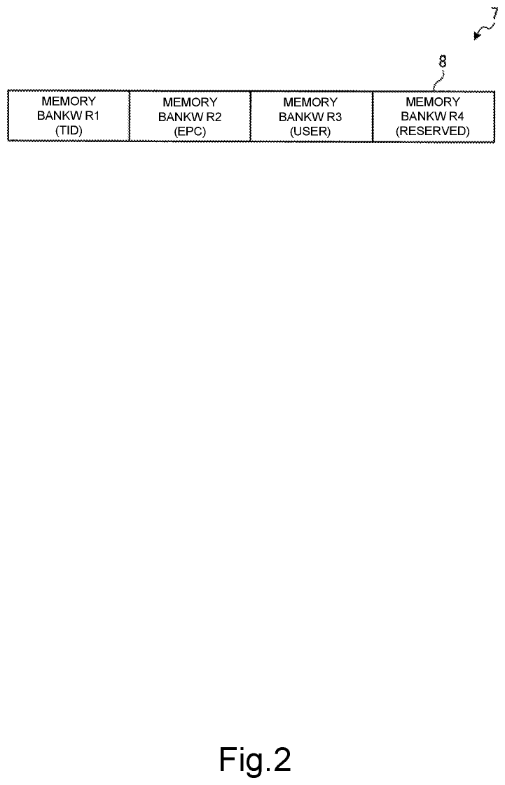

The IC chips 7 (7a, 7b, 7c, . . . ) respectively include drive circuits (not shown) and memories 8 (8a, 8b, 8c, . . . ). The drive circuits each generate an electromotive force by electromagnetic induction by a radio wave received by the corresponding RFID tag 4 to operate the RFID tag 4. That is, the RFID tags 4 are each a passive tag without a battery. The memories 8 each store information relating to the respective RFID tags 4 as will be described below (see FIG. 2). Hereinafter, part or all of the information stored in the memory 8 will be collectively referred to as the tag information in some cases.

On a side of the surface (hereinafter, referred to as the back surface) of the label release liner 2 opposed to the surface to which the label sheets 3 are attached, black marks (5a, 5b, 5c, . . . ) are provided at positions (edge positions of the downstream side of the transport direction A) corresponding to the leading positions of the label sheets 3. The RFID printer apparatus detects the black marks 5 to determine the timings for performing printing on the respective label sheets 3.

The memory 8 of the IC chip 7 of the RFID tag 4 includes four types of information storage areas for storing the tag information. FIG. 2 schematically shows an example of the information storage areas of the memory 8 of the IC chip 7 of the RFID tag 4. As shown in FIG. 2, the memory 8 includes memory banks R1,R2,R3, and R4 having a predetermined bit length.

The memory bank R1 is a TID (Tag ID) area. The memory bank R2 is an EPC (Electronic product Code) area. The memory bank R3 is a USER area. The memory bank R4 is a RESERVED area.

The TID area is an area where only reading is possible. Further, the TID area is an area where information is written when the RFID tag 4 is shipped. In the TID area, for example, identification data (ID) capable of uniquely identifying the RFID tag 4, manufacturing information relating to the RFID tag 4, and the like are written. That is, information different for each of the RFID tags 4 (4a, 4b, 4c, . . . ) is stored in the TID area.

The EPC area is an area where reading and writing are possible. In the EPC area, information relating to an article such as a product to which the RFID tag 4 is to be attached is stored.

The USER area is an area where reading and writing are possible. In the USER area, information unique to a user, which is different from the standardized information to be written to the EPC area, is stored.

The RESERVED area is an area where reading and writing are possible. In the RESERVED area, a password and the like necessary when reading and writing the RFID tag 4 is stored.

(Configuration of Printer Apparatus)

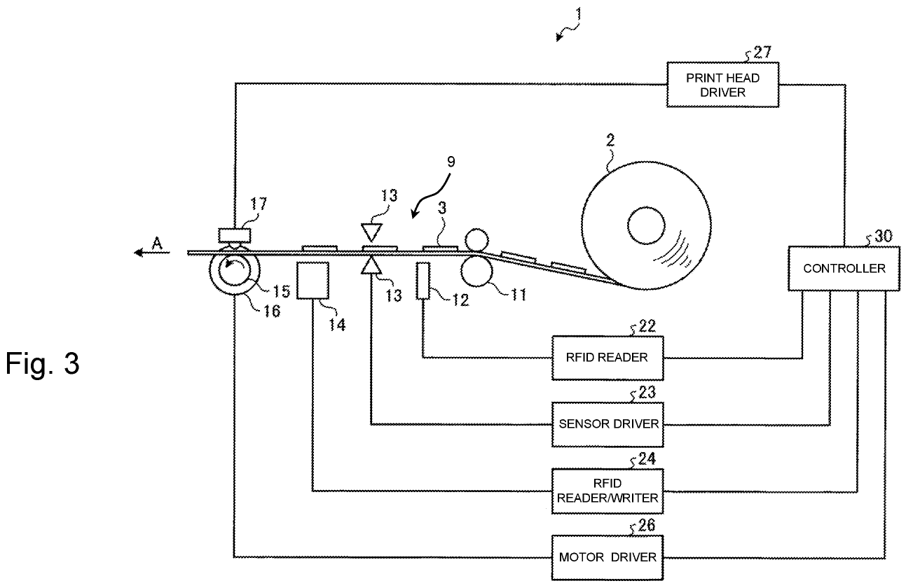

FIG. 3 shows a schematic configuration of the RFID printer apparatus according to the first embodiment. An RFID printer apparatus 1 pulls out the label release liner 2 wound in a roll shape, and performs printing on the plurality of label sheets 3 attached to the label release liner 2 while transporting the label release liner 2 along a transport path 9 of the label release liner 2. Further, the RFID printer apparatus 1 writes information to the RFID tag 4 formed on the respective label sheets 3 while transporting the label release liner 2. Note that the RFID tag 4 is an example of a wireless tag.

As shown in FIG. 3, the RFID printer apparatus 1 pulls out the label release liner 2 and transports the label release liner 2 in the transport direction A by the rotational driving force of the platen roller 15 that is a part of the transport mechanism for the label release liner 2. The RFID printer apparatus 1 includes the transport roller 11, an RFID antenna 12, a mark sensor 13, an RFID antenna 14, the platen roller 15, a stepping motor 16, and a print head 17 in the stated order from the upstream side of the transport direction A along the transport path 9 in the vicinity of the transport path 9 of the label release liner 2. Further, the RFID printer apparatus includes an RFID reader (wireless reader) 22, a sensor driver 23, an RFID reader/writer (wireless reader/writer) 24, a motor driver 26, a print head driver 27, and a controller 30.

The transport roller 11 that is a part of the transport mechanism for the label release liner 2 rotates along with the movement of the label release liner 2 to guide the label release liner 2 to a predetermined transport path 9.

The RFID antenna 12 is controlled by the RFID reader 22. The RFID reader 22 causes the RFID antenna 12 to irradiate the RFIT tag 4 on the label release liner 2 with an unmodulated wave (electromagnetic wave). Hereinafter, the unmodulated wave will be referred to simply as a radio wave. The RFID reader 22 performs wireless communication with the RFID tag 4 via the RFID antenna 12 by using the unmodulated wave from the RFID antenna 12. The RFID tag 4 is activated upon receiving this radio wave. Then, the RFID tag 4 irradiates the RFID antenna 12 with a response radio wave to return the information stored in the TID area (see FIG. 2) of the memory 8 to the RFID antenna 12 of the RFID reader 22. Then, the RFID antenna 12 receives this response radio wave. In this way, the RFID reader 22 reads the tag information, specifically, the information stored in the above-mentioned TID area, by communicating with the RFID tag 4. Further, the irradiation range of the radio wave of the RFID antenna 12 is set to be narrower than the irradiation range of the radio wave of the RFID antenna 14 described below, by narrowing the window for applying the radio wave from the antenna. Therefore, the RFID antenna 12 reliably receives the tag information of the RFID tag 4 in a pinpointed way. That is, the RFID reader 22 reliably reads the tag information of the RFID tag 4 via the RFID antenna 12. Note that the RFID antenna 12 is an example of a radio wave transmission/reception means in this embodiment.

The mark sensor 13 is a reflection type optical sensor that optically detects the black mark 5 (see FIG. 1) indicating the reference position, which is provided on the label release liner 2, from the side of the back surface of the printing surface on which printing is performed by the print head 17 described below. The mark sensor 13 is controlled by the sensor driver 23, and scans, along the transport direction A, the back surface of the label release liner 2 transported on the transport path. For example, the mark sensor 13 outputs an ON signal when detecting the edge of the black mark 5 on the downstream side of the transport direction A, and outputs an OFF signal when detecting the edge on the upstream side. The position of the black mark 5 and the position of the label sheet 3 have a predetermined relationship. For example, in the example in FIG. 1, the position of the edge of the black mark 5 on the upstream side and the position of the edge of the label sheet 3 on the downstream side match. Therefore, detection of the edge of the black mark 5 on the upstream side by the mark sensor 13 means detection of the edge of the label sheet 3 on the downstream side. In this way, the RFID printer apparatus 1 specifies the position of the label sheet 3 on the basis of the detection result of the black mark 5.

Note that the method of specifying the position of the label sheet 3 is not limited thereto, and a transmission type mark sensor 13 may be used. That is, a transmission sensor that is provided on the transport path 9 and includes a light reception unit provided on the side of the printing surface of the label sheet 3 and a light emission unit provided on the side of the surface that is not the printing surface may be used. The light emitted from the light emission unit is transmitted through the label release liner 2 or through the label release liner 2 and the label sheets 3, and detected by the light reception unit. The intensity of the light detected by the light reception unit is smaller in the case where the light has been transmitted through the label release liner 2 and the label sheets 3 as compared with the case where the light has been transmitted through only the label release liner 2. That is, the position where the intensity of the light detected by the light reception unit switches from small to large corresponds to the edge of the label sheet 3 on the upstream side. Further, the position where the intensity of the light detected by the light reception unit switches from large to small corresponds to the edge of the label sheet 3 on the downstream side.

Note that the mark sensor 13 may include a reflection type sensor and a transmission sensor, and the mark sensor 13 to be used may be switched depending on the type of the label release liner 2 to be transported. FIG. 3 shows an example in which the mark sensor 13 includes a reflection type sensor and a transmission type sensor. Further, the installation position of the mark sensor 13 is not limited to the position shown in FIG. 3. That is, the mark sensor 13 may be installed between the transport roller 11 and the RFID antenna 12.

The RFID antenna 14 is controlled by the RFID reader/writer 24. The RFID reader/writer 24 causes the RFID antenna 14 to irradiate the RFID tag 4 on the label release liner 2 with a radio wave. The RFID reader/writer 24 performs wireless communication with the RFID tag 4 via the RFID antenna 14 by using the radio wave from the RFID antenna 14. The RFID tag 4 is activated upon receiving this radio wave. Then, the RFID tag 4 irradiates the RFID antenna 14 with a response radio wave to return the information stored in the TID area of the memory 8 to the RFID antenna 14 of the RFID reader/writer 24. Then, the RFID antenna 14 receives this response radio wave. In this way, the RFID reader/writer 24 reads the tag information of the RFID tag 4, specifically, the information stored in the above-mentioned TID area, by communicating with the RFID tag 4. Further, the RFID reader/writer 24 causes the RFID antenna 14 to apply a radio wave to transmit the information (writing data described below) corresponding to the above-mentioned read tag information from the RFID antenna 14 to the RFID tag 4 whose tag information has been read. Then, the RFID tag 4 writes the above-mentioned received information to the EPC area or the USER area of the memory 8. In this way, the RFID reader/writer 24 writes predetermined information to the EPC or the USER area by communicating with the RFID tag 4. That is, the RFID antenna 14 is used for both reading the tag information of the RFID tag 4 and writing information to the RFID tag 4. Further, the irradiation range of the radio wave of the RFID antenna 14 is set to be wider than that of the RFID antenna 12. As a result, the RFID antenna 14 is capable of writing information to the RFID tag 4, on the upstream side as much as possible. That is, the RFID reader/writer 24 is capable of writing the information to the RFID tag 4 via the RFID antenna 14, on the upstream side as much as possible. Therefore, it is possible to reliably write information to the RFID tag 4 and perform printing on the label sheet 3 by the print head 17 while transporting the label release liner 2 at a certain speed. Note that the RFID antenna 14 is an example of a radio wave transmission/reception means in this embodiment.

The print head 17 is connected to the print head driver 27. The print head driver 27 drives the print head 17. The print head 17 prints information relating to an article such as a product, e.g., print data indicating an article name and a price on the printing surface of the label sheet 3 on the label release liner 2 transported along with the rotation of the platen roller 15. The information relating to an article such as a product includes print data indicating an article name, a price, and the like.

The platen roller 15 rotates in accordance with the rotation of the stepping motor 16 driven by the motor driver 26. The label release liner 2 wound in a roll shape is pulled out along with the rotation of the platen roller 15, and transported in the transport direction A. Note that the stepping motor 16 is capable of rotating in either clockwise or counter clockwise. When transporting the label release liner 2 along the transport direction A, the stepping motor 16 rotates counterclockwise. Meanwhile, when moving the label release liner 2 in the direction opposite to the transport direction A, the stepping motor 16 rotates clockwise.

The label sheet 3 on which printing has been performed is peeled off from the label release liner 2 by a peeling mechanism (not shown). The label sheet 3 peeled off from the label release liner 2 is attached to a corresponding article such as a product.

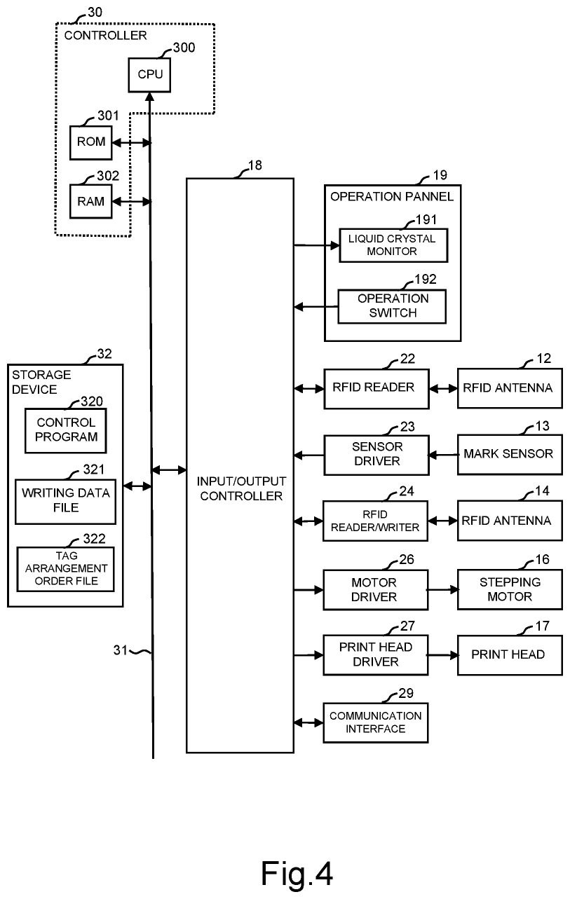

The RFID reader 22, the sensor driver 23, the RFID reader/writer 24, the motor driver 26, and the print head driver 27 described above are connected to the controller 30 described below. Further, in addition thereto, an operation panel 19 and a communication interface 29 shown in FIG. 4 are connected to the controller 30.

The operation panel 19 has an interface function with a user. As shown in FIG. 4, the operation panel 19 includes a liquid crystal monitor 191 and an operation switch 192. Note that the operation switch 192 may be a touch panel that is stacked and disposed on the liquid crystal monitor 191, or may be a mechanical switch independent of the liquid crystal monitor 191.

The communication interface 29 has an interface function between the RFID printer apparatus 1 and a host apparatus such as a store server. The RFID printer apparatus 1 receives data to be written to the RFID tag 4, data to be printed on the label sheet 3, and the like from the host apparatus via the communication interface 29.

(Hardware Configuration of RFID Printer Apparatus)

Next, a hardware configuration of the RFID printer apparatus 1 will be described with reference to FIG. 4. FIG. 4 shows an example of the hardware configuration of the RFID printer apparatus. As shown in FIG. 4, the RFID printer apparatus 1 includes the controller 30, a storage device 32, and an input/output controller 18.

As shown in FIG. 4, the controller 30 is a general computer including a processor 300, a ROM (Read Only Memory) 301, and a RAM (Random Access Memory) 302. Further, the processor 300 is, for example, a CPU (Central Processing Unit) 300. The CPU 300 reads various programs, data files, and the like stored in the ROM 301 and/or the storage device 32 described below and expands them into the RAM 302. The CPU 300 operates in accordance with the various programs, data files, and the like expanded into the RAM 302 to control the entire RFID printer apparatus 1.

As shown in FIG. 4, the controller 30 is connected to the storage device 32 and the input/output controller 18 via an internal bus 31.

The storage device 32 holds the storage information even when the power is turned off. The storage device 32 is specifically a non-volatile memory such as a flash memory. Further, the storage device 32 may include an HDD (Hard Disk Drive) instead of the flush memory. As shown in FIG. 4, the storage device 32 stores a program and the like including a control program 320. The control program 320 is a program for realizing the function of the RFID printer apparatus 1. Note that the control program 320 may be provided be being incorporated in the ROM 301 in advance. Further, the control program 320 may be provided by being recorded on a computer-readable recording medium such as a CD-ROM, a flexible disk (FD), a CD-R, and a DVD (Digital Versatile Disc) as a file in a format that can be installed or executed in the controller 30. Further, the control program 320 may be provided by being stored on a computer connected to a network such as the Internet and downloaded via the network.

As shown in FIG. 4, the storage device 32 further stores a writing data file 321 and a tag arrangement order file 322.

The writing data file 321 is a file in which data to be written to the RFID tags 4 (4a, 4b, 4c, . . . ) and print data to be printed on the label sheets 3 stored in association with each other. The writing data file 321 stores writing data to be written to the RFID tags 4 and print data to be printed on the label sheets 3, in the arrangement order of the RFID tags 4. The arrangement order of the RFID tags 4 is the arrangement order of the RFID tags 4 in the transport direction A of the label release liner 2. Note that the writing data file 321 is a file corresponding to the label release liner 2. Therefore, the writing data file 321 corresponding to the label release liner 2 set in the RFID printer apparatus 1 is used. Then, the total number of RFID tags 4 formed on the label sheets 3 attached to the label release liner 2 and the number of pieces of writing data stored in the writing data file 321 are equal to each other. Further, the number of label sheets 3 attached to the label release liner 2 and the number of pieces of print data are equal to each other. The RFID printer apparatus 1 acquires the writing data file 321 from, for example, a host apparatus such as a store server.

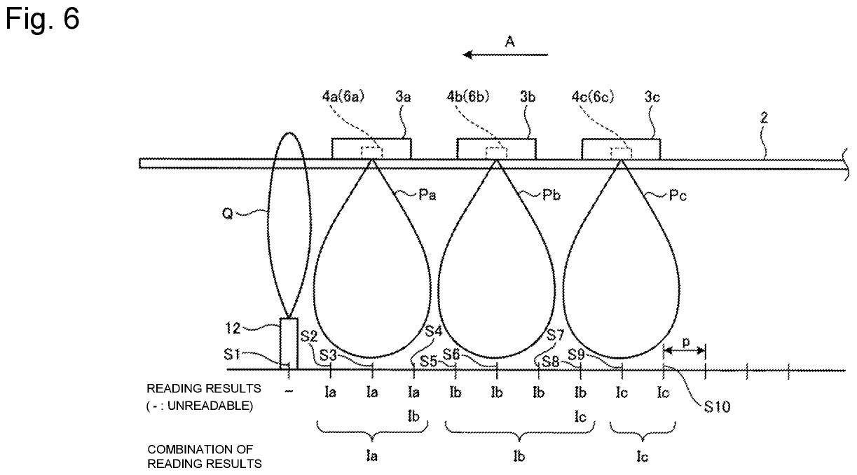

The tag arrangement order file 322 is a file in which information indicating the arrangement order of the RFID tags (4a, 4b, 4c, . . . ) attached to the label release liner 2 is stored. Note that the arrangement order of the RFID tags 4 in the label release liner 2 is detected by the RFID reader 22. Specifically, the RFID reader 22 reads the tag information stored in the TID area of the RFID tags 4 (4a, 4b, 4c, . . . ). The tag arrangement order file 322 stores the tag information read by the RFID reader 22. Details thereof will be described below (see FIG. 6).

Note that although not shown in FIG. 4, the storage device 32 further stores specification information of the label release liner 2 set in the RFID printer apparatus 1. The specification information of the label release liner 2 includes pieces of information regarding the number of label sheets 3 attached to the label release liner 2, the size of the label sheet 3 in the transport direction, the distance between the adjacent label sheets 3, and the transport amount of the label release liner 2.

The input/output controller 18 connects the controller 30 to input/output devices that perform various settings and operation control of the RFID printer apparatus 1.

Specifically, the input/output controller 18 connects the controller 30 to the operation panel 19, the RFID reader 22, the sensor driver 23, the RFID reader/writer 24, the motor driver 26, the print head driver 27, and the communication interface 29 The outline of each of the input/output devices are as described above.

(Functional Configuration of RFID Printer Apparatus)

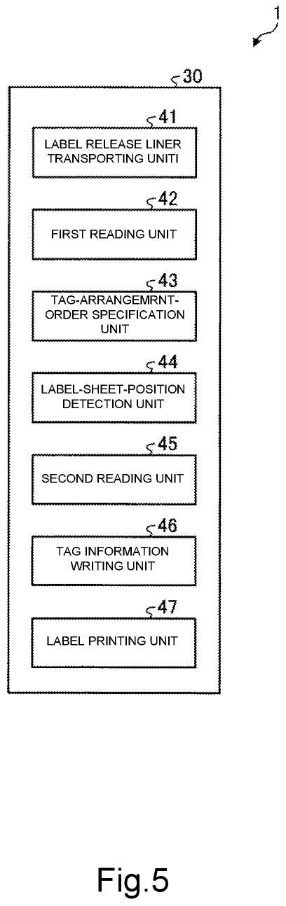

Next, a functional configuration of the RFID printer apparatus 1 will be described with reference to FIG. 5. FIG. 5 shows an example of a functional configuration of the RFID printer apparatus. The CPU 300 of the controller 30 of the RFID printer apparatus 1 expands the control program 320 into the RAM 302 and executes the control program, thereby operating as functional units including a label release liner transporting unit 41, a first reading unit 42, a tag-arrangement-order specification unit 43, a label-sheet-position detection unit 44, a second reading unit 45, a tag information writing unit 46, and a label printing unit 47 shown in FIG. 5.

The label release liner transporting unit 41 shown in FIG. 5 causes, via the motor driver 26, the stepping motor 16 to rotate. As a result, the label release liner transporting unit 41 causes the platen roller 15 that is a part of the transport mechanism to rotate to transport the label release liner 2 at a predetermined transport speed. Note that a plurality of label sheets 3 and a plurality of RFID tags 4 (wireless tags) formed in the vicinity of the label sheets 3 or so as to overlap the label sheets 3 are disposed on the label release liner 2. Further, the label release liner transporting unit 41 determines, on the basis of the specification information of the label release liner 2 stored in the storage device 32, whether or not all of the label sheets 3 attached to the label release liner 2 have been transported. As described above, the specification information of the label release liner 2 includes pieces of information regarding the number of label sheets 3 attached to the label release liner 2, the size of the label sheet 3 in the transport direction, the distance between the adjacent label sheets 3, and the transport amount of the label release liner 2. Note that the label release liner transporting unit 41 is an example of the transport means in this embodiment.

The first reading unit 42 shown in FIG. 5 controls the RFID reader 22 to cause the RFID reader 22 to read the tag information stored in the RFID tag 4. The RFID reader 22 sequentially reads, from all of the RFID tags 4 (wireless tags) on the label release liner 2 transported on the transport path 9, the pieces of tag information stored in the memories 8 of the RFID tags 4. Then, the first reading unit 42 acquires the tag information stored in the RFID tag 4 via the RFID reader 22. Note that the first reading unit 42 is an example of a first reading means in this embodiment.

The tag-arrangement-order specification unit 43 shown in FIG. 5 combines reading results from the same RFID tag 4 among a plurality of reading results (pieces of acquired tag information) of the RFID reader 22 acquired by the first reading unit 42 to specify the arrangement order of the RFID tags 4. Then, the tag-arrangement-order specification unit 43 arranges the combined reading results in order to generate the tag arrangement order file 322. Note that the tag-arrangement-order specification unit 43 is an example of a reading result combining means in this embodiment. Further, the above-mentioned combination of the reading results will be described below with reference to FIG. 6 and the like.

The label-sheet-position detection unit 44 shown in FIG. 5 causes, via the sensor driver 23, the mark sensor 13 to detect the end of the label sheet 3. The label-sheet-position detection unit 44 acquires, via the sensor driver 23, the detection results of the end of the label sheet 3 by the mark sensor 13 to grasp the position of the end of the label sheet 3. The label printing unit 47 shown in FIG. 5 determines, on the basis of the position of the end of the label sheet 3 thus grasped and the transport speed of the label release liner 2 described above, the timing to start performing printing on the label sheet 3.

The second reading unit 45 shown in FIG. 5 acquires, on the downstream side of the transport direction A from the first reading unit 42, the tag information stored in the RFID tag 4 (wireless tag). That is, the second reading unit 45 controls the RFID reader/writer 24 to cause the RFID reader/writer 24 to read the tag information stored in the RFID tag 4. The RFID reader/writer 24 uses the RFID antenna 14 provided on the downstream side from the position of the RFID antenna 12 to read, from the RFID tag 4(wireless tag), the tag information stored in the RFID tag 4. More specifically, the RFID reader/writer 24 reads the information stored in the TID area of the memory 8 of the RFID tag 4 as described above. Then, the second reading unit 45 acquires, via the RFID reader/writer 24, the information stored in the TID area of the memory 8 of the RFID tag 4. Note that the second reading unit 45 is an example of a second reading means in this embodiment.

The tag information writing unit 46 shown in FIG. 5 determines whether or not the tag information acquired by the second reading unit 45 and the tag information acquired by the first reading unit 42 are the same with each other. Then, on a condition that the second reading unit 45 has acquired the tag information that is the same as the tag information acquired by the first reading unit 42, the tag information writing unit 46 causes the RFID reader/writer 24 to write the information (writing data) corresponding to the tag information acquired by the first reading unit 42 to the RFID tag 4 (wireless tag). In other words, under a condition that the RFID reader/writer 24 has read the tag information that is the same as the tag information read by the RFID reader 22, the RFID reader/writer 24 writes, to the RFID tags4 (wireless tag), the information corresponding to the tag information read by the RFID reader 22. More specifically, the tag information writing unit 46 causes the RFID reader/writer 24 to write, to the RFID tag 4, the first information among the pieces of information (writing data) stored in the writing data file 321. Then, after the writing of information is finished, the tag information writing unit 46 updates the writing data file 321 by deleting the written information from the writing data file 321 and incrementing the order of the second information and subsequent information. Further, the tag information writing unit 46 updates the tag arrangement order file 322 by deleting the first information among the pieces of information stored in the tag arrangement order file 322 and incrementing the order of the second information and subsequent information. Note that the tag information writing unit 46 is an example of a writing means in this embodiment.

However, there is a possibility that the second reading unit 45 acquires, from the RFID tag 4 adjacent to the target RFID tag 4 in the label release liner 2, the same tag information as the tag information acquired by the first reading unit 42. That is, there is a possibility that the RFID reader/writer 24 reads, from the above-mentioned adjacent RFID tag 4, the same tag information as the tag information read by the RFID reader 22. For this reason, it is favorable that the tag information writing unit 46 determines an appropriate writing position by that pieces of tag information of the RFID tags 4 are acquired at a plurality of reading positions and the intensity of each of the radio waves are measured while the label release liner 2 is transported in the transport direction A. Specifically, the second reading unit 45 acquires the same tag information as the tag information acquired by the first reading unit 42 sequentially at the plurality of reading positions, and measures the intensity of the radio wave. Then, in the case where the intensity of the radio wave exceeds a predetermined threshold value, the label release liner transporting unit 41 controls the stepping motor 16 via the motor driver 26 to return the target RFID tag 4 on the label release liner 2 to the center of the reading position satisfying a predetermined condition. It is favorable that the tag information writing unit 46 writes information on the returned RFID tag 4.

The label printing unit 47 controls the print head driver 27 to cause the print head to print label information on the label sheet 3. The label information is, for example, a product name or a price.

(Description of Processing Performed by Tag-Arrangement-Order Specification Unit)

Next, the content of the processing of specifying the arrangement order of the RFID tags 4 (wireless tags), which is performed by the tag-arrangement-order specification unit 43, will be described using FIG. 6. FIG. 6 shows a method of specifying the arrangement order of the RFID tags on the basis of the tag information acquired by the first reading unit 42 (first reading means).

The first reading unit 42 acquires the information stored in the TID area of the RFID tag 4 by reading by the RFID reader 22 every time the label release liner transporting unit 41 transports the label release liner 2 by a predetermined amount (one pitch). FIG. 6 shows the state where the RFID reader 22 has actually read the pieces of tag information stored in the RFID tags 4a, 4b, and 4c in a plurality of reading positions S1 to S10. Note that the RFID antenna 12 of the RFID reader 22 is fixed, and the RFID reader 22 read the RFID tag 4 every time the label release liner 2 is moved by one pitch. Meanwhile, in order to make the description easy to understand, description will be made in FIG. 6 assuming that reading from the RFID tag 4 is performed while moving the RFID antenna 12. That is, assumption is made that the RFID tag 4 is read while moving the RFID antenna 12 by one pitch in the direction opposite to the transport direction A of the label release liner 2. Therefore, the plurality of reading positions described above is relative positions relative to the RFID tags 4a, 4b, and 4c. Note that pieces of information Ia, Ib, and Ic are respectively stored in the RFID tags 4a, 4b, and 4c. Further, assumption is made that the transport amount corresponding to the one pitch when transporting the label release liner 2 is a transport amount p shown in FIG. 6.

In FIG. 6, in the case where an operation of reading the RFID tag 4 by the RFID reader 22 is performed when the RFID antenna 12 is at the position S1, a radio wave reception area Q of the RFID antenna 12 and radio wave transmission areas Pa, Pb, and Pc of the RFID tags 4a, 4b, and 4c do not overlap with each other. For this reason, the RFID antenna 12 of the RFID reader 22 does not receive information from the RFID tags 4a, 4b, and 4c. Therefore, no reception result is obtained (indicated by “-” in FIG. 6).

Next, in the case where an operation of reading the RFID tag 4 by the RFID reader 22 is performed when the RFID antenna 12 is moved by one pitch (transport amount p) to be at the position S2, the reception area Q of the RFID antenna 12 and the radio wave transmission area Pa of the RFID tag 4a overlap with each other. For this reason, the RFID antenna 12 of the RFID reader 22 receives the information Ia of the RFID tag 4a. That is, the first reading unit 42 acquires the information Ia by the reading operation by the RFID reader 22.

By such reading is sequentially performed, the reading results shown in FIG. 6 can be obtained in the respective positions S1 to S10. In the boundary area between adjacent RFID tags, there are a case where no reception results is obtained as in the position S1 and a case where pieces of information of adjacent two RFID tags are received as in the positions S4 and S8. That is, at the position S4, the RFID antenna 12 of the RFID reader 22 receives the information Ia of the RFID tag 4a and the information Ib of the RFID tag 4b adjacent to the RFID tag 4a. Further, at the position S8, the RFID antenna 12 of the RFID reader 22 receives the information Ib of the RFID tags 4b and the information Ic of the RFID tag 4c adjacent to the RFID tag 4b.

The tag-arrangement-order specification unit 43 specifies the arrangement order of the RFID tags 4a, 4b, and 4c with respect to the plurality of reading results thus obtained. Specifically, the tag-arrangement-order specification unit 43 combines the reading results at the positions S1 to S10 shown in FIG. 6 for each of the reading results from the same RFID tag 4.

As described above, different information is stored in the TID area of each of the RFID tags 4. For this reason, the tag-arrangement-order specification unit 43 combines the reading results by regarding, as the position at which the information of the same RFID tag 4 has been read, the position at which the same information Ii(i=a,b,c, . . . ) has been read among the reading results of the RFID reader 22. Then, the tag-arrangement-order specification unit 43 stores, in the above-mentioned tag arrangement order file 322, the information Ii(i=a,b,c, . . . ) in the combined reading results as information indicating the arrangement order of the RFID tags 4.

For example, in FIG. 6, the positions at which the same information Ia has been read are the positions S2, S3, and S4. Further, the positions at which the same information Ib has been read are the positions S5, S6, S7, and S8. However, at the position S4, the plurality of pieces of information Ia and Ib is simultaneously read. Further, at the position S8, the plurality of pieces of information Ib and Ic is simultaneously read. In such a case, the same information as the information read on the downstream side, i.e., the position S3 or S7 may be prioritized, or the same information as the information read on the upstream side, i.e., the position S5 or S9 may be prioritized. In the case where the information read on the downstream side is prioritized, the tag-arrangement-order specification unit 43 determines that the information Ia has been read at the position S4. That is, the tag-arrangement-order specification unit 43 combines the reading results by regarding the positions S2, S3, and S4 as the positions at which the information Ia of the same RFID tag 4a has been read. Further, the tag-arrangement-order specification unit 43 determines that the information Ib has been read at the position S8. That is, the tag-arrangement-order specification unit 43 combines the reading results by regarding the positions S5, S6, S7, and S8 as the positions at which the information Ib of the same RFID tag 4b has been read. Meanwhile, when the information read on the upstream side is prioritized, the tag-arrangement-order specification unit 43 determines that the information Ib has been read at the position S4. Further, the tag-arrangement-order specification unit 43 determines that the information Ic has been read at the position S8.

The example shown in FIG. 6 shows the case where the information read on the downstream side is prioritized in combining the reading results. That is, the tag-arrangement-order specification unit 43 determines that the information Ia has been read by the RFID reader 22 at the position S4. Further, the tag-arrangement-order specification unit 43 determines that the information Ib has been read by the RFID reader 22 at the position S8. Therefore, the tag-arrangement-order specification unit 43 determines that the information Ia has been read at the positions S2 to S4, the information Ib has been read at the positions S5 to S8, and the positions Ic has been read at the positions S9 and S10.

As a result, the tag-arrangement-order specification unit 43 specifies, as the arrangement order of the RFID tags 4, the order of the pieces of information Ia, Ib, and Ic stored in the respective RFID tags 4, i.e., the order of the RFID tag 4a, the RFID tag 4b, and the RFID tag 4c. Then, the tag-arrangement-order specification unit 43 stores, in the tag arrangement order file 322, the information Ia, the information Ib, and the information Ic in the stated order as the arrangement order of the RFID tags 4. In other words, the tag-arrangement-order specification unit 43 generates the tag arrangement order file 322 in which the information Ia, the information Ib, and the information Ic have been stored in the stated order as the arrangement order of the RFID tags 4.

(Description of Flow of Processing Performed by RFID Printer Apparatus)

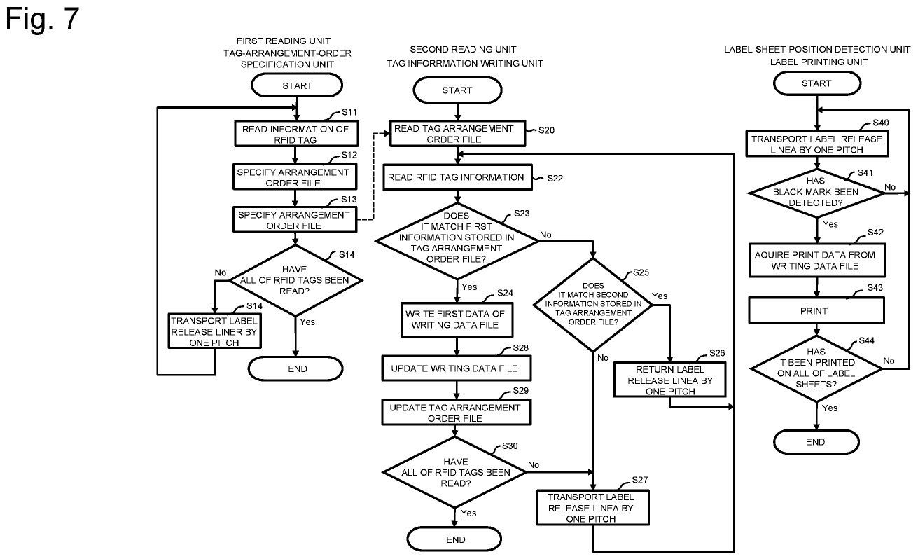

Next, the processing performed by the RFID printer apparatus 1 will be described using FIG. 7. FIG. 7 shows an example of a series of processes executed by the CPU 300 of the RFID printer apparatus according to the embodiment operating as the above-mentioned functional units.

First, the flow of the processing executed by the CPU 300 operating as the first reading unit 42 and the tag-arrangement-order specification unit 43 will be described. In Step S11 shown in FIG. 7, the first reading unit 42 causes the RFID reader 22 to read the tag information stored in the TID area of the RFID tag 4.

Next, in Step S12, the tag-arrangement-order specification unit 43 specifies the arrangement order of the RFID tags 4. The method of specifying the arrangement order is as described above (see FIG. 6).

Subsequently, in Step S13, the tag-arrangement-order specification unit 43 generates the tag arrangement order file 322.

In Step S14, the label release liner transporting unit 41 determines whether or not all of the RFID tags 4 have been read. In the case where it is determined that the pieces of the tag information of all of the RFID tags 4 on the label release liner 2 transported on the transport path 9 have been read (Step S14: Yes), the CPU 300 as the first reading unit 42 and the tag-arrangement-order specification unit 43 finishes the processing shown in FIG. 7. Meanwhile, in the case where it is not determined that the pieces of the tag information of all of the RFID tags 4 have been read (Step S14: No), the processing of the CPU 300 proceeds to Step S15.

In Step S15, the label release liner transporting unit 41 controls the stepping motor 16 via the motor driver 26 to transport the label release liner 2 by one pitch in the transport direction A.

Next, the processing executed by the CPU 300 operating as the second reading unit 45 and the tag information writing unit 46 will be described. First, in Step S20 shown in FIG. 7, the second reading unit 45 reads the tag arrangement order file 322.

Subsequently, in Step S22, the second reading unit 45 causes the RFID reader/writer 24 to read the tag information stored in the TID area of the RFID tag 4.

Next, in Step S23, the tag information writing unit 46 determines whether or not the tag information read by the RFID reader/writer 24 (see Step S22) matches the first information stored in the tag arrangement order file 322. In the case where it is determined that the tag information read by the RFID reader/writer 24 matches the first information stored in the tag arrangement order file 322 (Step S23: Yes), the processing of the CPU 300 proceeds to Step S24. Meanwhile, in the case where it is not determined that the tag information read by the RFID reader/writer 24 matches the first information stored in the tag arrangement order file 322 (Step S23:No), the processing of the CPU 300 proceeds to Step S25.

In Step S24, the tag information writing unit 46 controls the RFID reader/writer 24 to write the first data of the writing data file 321 to the RFID tag 4. Note that the tag information writing unit 46 may determine a more appropriate writing position on the basis of the pieces of tag information read by the RFID reader/writer 24 at a plurality of reading positions and the intensity of each of the radio waves at that time as described above.

Next, in Step S28, the tag information writing unit 46 deletes the data written in Step S24 from the writing data file 321. At the same time, the tag information writing unit 46 updates the writing data file 321 by incrementing the order of the second data and subsequent data.

Subsequently, in Step S29, the tag information writing unit 46 deletes the first data of the tag arrangement order file 322. At the same time, the tag information writing unit 46 updates the tag arrangement order file 322 by incrementing the order of the second data and subsequent data.

In Step S30, the label release liner transporting unit 41 determines whether or not all of the RFID tags 4 have been read. In the case where it is determined that the pieces of information of all of the RFID tags 4 have been read (Step S30: Yes), the CPU 300 as the second reading unit 45 and the tag information writing unit 46 finishes the processing shown in FIG. 7. Meanwhile, in the case where it is not determined that the pieces of information of all of the RFID tags 4 have been read (Step S30: No), the processing of the CPU 300 proceeds to Step S27.

Further, in the case where it is not determined in Step S23 that the tag information read by the RFID reader/writer 24 matches the first information stored in the tag arrangement order file 322 (Step S23: No), the processing of the CPU 300 proceeds to Step S25 as described above. In Step S25, the tag information writing unit 46 determines whether or not the tag information read in Step S22 matches the second information stored in the tag arrangement order file 322. In the case where it is determined that the tag information read in Step S22 matches the second information stored in the tag arrangement order file 322 (Step S25: Yes), the processing of the CPU 300 proceeds to Step S26. Meanwhile, in the case where it is not determined that the tag information read in Step S22 matches the second information stored in the tag arrangement order file 322 (Step S25: No), the processing of the CPU 300 proceeds to Step S27.

In Step S26, the label release liner transporting unit 41 controls the stepping motor 16 via the motor driver 26 to return the label release liner 2 by one pitch in the direction opposite to the transport direction A. After that, the processing of the CPU 300 returns to Step S22 and the CPU 300 continues the above-mentioned processing.

Further, in Step S27, the label release liner transporting unit 41 controls the stepping motor 16 via the motor driver 26 to transport the label release liner 2 by one pitch in the transport direction A. After that, the processing of the CPU 300 returns to Step S22 and the CPU 300 continues the above-mentioned processing.

Note that in the above-mentioned Step S24, the tag information writing unit 46 may instruct the RFID reader/writer 24 to write the first data of the writing data file 321 to the RFID tag 4 having the TID area in which predetermined information (tag information read by the RFID reader 22) has been stored. As a result, the tag information writing unit 46 is capable of more reliably writing data to a predetermined RFID tag 4.

Next, the flow of the processing executed by the CPU 300 operating as the label-sheet-position detection unit 44 and the label printing unit 47 will be described. In Step S40 shown in FIG. 7, the label release liner transporting unit 41 controls the stepping motor 16 via the motor driver 26 to transport the label release liner 2 by one pitch in the transport direction A.

In Step S41, the label-sheet-position detection unit 44 determines whether or not the black mark 5 provided on the label release liner 2 has been detected by the mark sensor 13. In the case where it is determined that the black mark 5 has been detected (Step S41: Yes), the processing of the CPU 300 proceeds to Step S42. Meanwhile, in the case where it is not determined that the black mark 5 has been detected (Step S41: No), the processing of the CPU 300 returns to Step S40.

In Step S42, the label printing unit 47 acquires print data from the writing data file 321.

In Step S43, the label printing unit 47 controls the print head driver 27 to cause the print head 17 to print the acquired print data on the label sheet 3.

In Step S44, the label release liner transporting unit 41 determines whether or not print data has been printed on all of the label sheets 3. In the case where it is determined that print data has been printed on all of the label sheets 3 (Step S44:Yes), the CPU 300 that operates as the label printing unit 47 finishes the processing shown in FIG. 7. Meanwhile, in the case where it is not determined that print data has been printed on all of the label sheets 3 (Step S44:No), the processing of the CPU 300 returns to Step S40 and the CPU 300 repeats the above-mentioned processing. Note that whether or not print data has been printed on all of the label sheets 3 only needs to be determined by, for example, comparing the number of label sheets 3 attached to the label release liner 2, which is stored in the storage device 32 in advance, and the number of times of actual printing by the print head 17 under the control of the label printing unit 47.

As described above, in the RFID printer apparatus 1 (wireless tag writing apparatus) according to the embodiment, the RFID reader 22 controlled by the first reading unit 42 (first reading means) sequentially reads, from all of the RFID tags 4 (wireless tags) on the label release liner 2 transported on the transport path 9, the tag information stored in the corresponding RFID tag 4. Further, the RFID reader/writer 24 controlled by the second reading unit 45 (second reading means) reads, at the reading position on the downstream side from the reading position of the RFID reader 22, the tag information stored in the RFID tag 4 on the label release liner 2 transported on the transport path 9. Then, under a condition that the RFID reader/writer 24 controlled by the second reading unit 45 has read the same information as the information read by the RFID reader 22, the RFID reader/writer 24 controlled by the tag information writing unit 46 (writing means) writes the information corresponding to the information read by the RFID reader 22 to the RFID tag 4. Therefore, the arrangement order of the RFID tags 4 is specified on the basis of the information read by the RFID reader 22 controlled by the first reading unit 42, and writing data prepared in advance is written in the specified arrangement order. Therefore, according to this embodiment, it is possible to reliably write information to a predetermined RFID tag 4.

Further, in the RFID printer apparatus 1(wireless tag writing apparatus) according to the embodiment, the tag-arrangement-order specification unit 43 (reading result combining means) combines the reading results read from the same RFID tag 4 (wireless tag) among the plurality of reading results read by the RFID reader 22 controlled by the first reading unit 42 (first reading means). Therefore, according to this embodiment, it is possible to reliably specify the arrangement order of the RFID tags 4 with simple processing.

Further, in the RFID printer apparatus 1 (wireless tag writing apparatus) according to the embodiment, reading of information by the RFID reader/writer 24 controlled by the second reading unit 45 (second reading means) and writing of information by the RFID reader/writer 24 controlled by the tag information writing unit 46 (writing means) are performed using the same RFID antenna 14 (radio wave transmission/reception means). Therefore, according to this embodiment, it is possible to simplify the apparatus configuration of the RFID printer apparatus 1.

Further, in the RFID printer apparatus 1 (wireless tag writing apparatus) according to the embodiment, the irradiation range of the radio wave of the RFID reader 22 controlled by the first reading unit 42 (first reading means) is set to be narrower than that of the RFID reader/writer 24 controlled by the second reading unit 45 (second reading means). Therefore, the RFID reader 22 controlled by the first reading unit 42 is capable of more reliably reading the information stored in the RFID tag 4 without being affected by the adjacent RFID tag.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless tag writing apparatus, comprising:
a transport mechanism that transports a label release liner on a predetermined transport path, a plurality of label sheets and a plurality of wireless tags formed on the respective label sheets being disposed on the label release liner, each of the wireless tags storing tag information relating to the corresponding wireless tag;
a storage device that stores information corresponding to the tag information stored in the corresponding wireless tag;
a wireless reader that sequentially reads, by applying a radio wave to the wireless tag on the label release liner transported on the transport path by the transport mechanism, the tag information from all of the wireless tags on the label release liner transported on the transport path;
a wireless reader/writer that reads, by applying a radio wave to the wireless tag on the label release liner, the tag information from the wireless tag at a position on a downstream side from a position of the wireless reader in a transport direction of the label release liner, and writes information corresponding to the tag information stored in the storage device to the wireless tag; and
a processor that controls, on a condition that the wireless reader/writer has read the same tag information as the tag information that has been read from the wireless tag by the wireless reader, the wireless reader/writer to cause the wireless reader/writer to write, by applying a radio wave to the wireless tag storing the same tag information that has been read by the wireless reader, the information corresponding to the tag information that has been read by the wireless reader among pieces of information stored in the storage device to the wireless tag.

2. The wireless tag writing apparatus according to claim 1, wherein
the wireless reader acquires a plurality of reading results by reading the tag information from each of the wireless tags at a plurality of relative positions relative to the wireless tags on the label release liner transported on the transport path.

3. The wireless tag writing apparatus according to claim 2, wherein
the processor combines a plurality of reading results including pieces of tag information from the same wireless tag among the plurality of reading results read by the wireless reader.

4. The wireless tag writing apparatus according to claim 3, wherein
the processor determines, as reading results including only pieces of tag information from the same wireless tag, reading results including the tag information from a wireless tag different from the same wireless tag in addition to the pieces of tag information from the same wireless tag among the plurality of reading results including the pieces of tag information from the same wireless tag.

5. The wireless tag writing apparatus according to claim 3, wherein
the processor determines, where a reading result of the wireless reader at a first relative position among the plurality of relative positions includes pieces of tag information from a plurality of wireless tags, that the reading result of the wireless reader at the first relative position is the same as a reading result of the wireless reader at a second relative position on the downstream side of the transport direction of the label release liner by prioritizing the reading result of the wireless reader at the second relative position over that at the first relative position.

6. The wireless tag writing apparatus according to claim 3, wherein
the processor specifies, by combining the plurality of reading results including the pieces of tag information from the same wireless tag, arrangement order of the wireless tags on the label release liner.

7. The wireless tag writing apparatus according to claim 1, wherein
the wireless reader/writer uses the same antenna provided in the vicinity of the transport path to irradiate the label release liner with a radio wave, thereby reading the tag information from the wireless tag and writing information to the wireless tag.

8. The wireless tag writing apparatus according to claim 7, wherein
the wireless reader uses an antenna provided in the vicinity of the transport path to irradiate the label release liner with a radio wave, thereby reading the tag information from the wireless tag, the antenna of the wireless reader/writer being provided at a position on the downstream side from the antenna of the wireless reader in the transport direction of the label release liner.

9. The wireless tag writing apparatus according to claim 7, wherein
an irradiation range of the radio wave of the antenna of the wireless reader is set to be narrower than an irradiation range of the radio wave of the antenna of the wireless reader/writer.

10. A writing method by a wireless tag writing apparatus, comprising:
transporting a label release liner on a predetermined transport path, a plurality of label sheets and a plurality of wireless tags formed on the respective label sheets being disposed on the label release liner, each of the wireless tags storing tag information relating to the corresponding wireless tag;
storing, in a storage device, information corresponding to the tag information stored in the corresponding wireless tag;
sequentially reading, by using a wireless reader to apply a radio wave to the wireless tag on the label release liner transported on the transport path, the tag information at a first position in the vicinity of the transport path from all of the wireless tags on the label release liner transported on the transport path;
reading, by using a wireless reader/writer to apply a radio wave to the wireless tag on the label release liner, the tag information from the wireless tag at a second position on a downstream side from the first position in a transport direction of the label release liner; and
on a condition that the tag information read at the second position is the same as the tag information read at the first position, writing, by applying a radio wave to the wireless tag storing the same tag information that has been read, information corresponding to the tag information that has been read at the first position among pieces of information stored in the storage device to the wireless tag.
